(19) United States
(12) Patent Application Publication
(10) Pub. No.: US 2010/0194315 A1
(43) Pub. Date: Aug. 5, 2010

(54) POWER TOOLS

(75) Inventors: Takuya KUSAKAWA, Anjo-shi (JP); Motohiro OMURA, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION, Anjo-shi (JP)

(21) Appl. No.: 12/689,755

(22) Filed: Jan. 19, 2010

(30) Foreign Application Priority Data
Feb. 3, 2009 (JP) 2009-022505

(51) Int. Cl. H02P 3/12; H02K 7/14

(52) U.S. Cl. 318/379; 310/50

(57) ABSTRACT

One aspect according to the present invention includes a power tool including a control device that can output a brake operation signal to a DC motor to apply a short-circuit brake thereto in response to turning off an operation switch. The brake operation signal is stopped depending on the rotational speed of the motor when the operation switch is turned off during the rotation of the DC motor.

This application claims priority to Japanese patent application serial number 2009-22505, the contents of which are incorporated herein by reference.

### BACKGROUND OF THE INVENTION

1. Field of the Invention

The present invention relates to power tools, and in particular power tools having a brush-less DC motor as a power source.

2. Description of the Related Art

Japanese Laid-Open Patent Publication No. 2008-296323 discloses a known screw tightening tool, in which a control unit outputs a brake operation signal during a predetermined time (normally about 300 ms) upon detection of release of a trigger-type operation switch (off operation), so that a brush-less DC motor is braked by a short-circuit brake. In general, in the case of an ordinary impact screwdriver, a brush-less DC motor is stopped after about 50 ms. Thus, in the know screw tightening tool, the brake operation signal may be outputted about 250 ms even after stopping of the DC motor.

In addition, in the known screw tightening tool, in order to suppress the current flowing through an electric circuit and to reduce a reaction of the screw tightening tool, the time required for the brush-less DC motor to reach a full speed is set to be long after the operation switch has been pulled (on operation).

For example, in some cases, an interior finish work of a house may include mounting a relatively soft wall material, such as plasterboards, by using screws. In such a case, if the screws are excessively tightened, depressions may be formed in the surface of the wall material. On the other hand, if the screws are insufficiently tightened, the screw heads may project from the surface of the wall material. Therefore, the tightening operation must be carefully performed to position the screw heads to be substantially flush with the surface of the wall material. To this end, a process of turning off the operation switch before completion of the tightening operation and subsequently turning on the operation switch soon after turning off the operation switch is repeatedly performed until completion of the tightening operation. This may enable the operator to check the position of the screw head for adjusting the tightening depth of the screw during the tightening operation until the screw head is brought to be flush with the surface of the wall material

As described previously, in the case of the known screw tightening tool, the brake operation signal is outputted during a predetermined time (about 300 ms) after the operation switch has been turned off. The brush-less DC motor can be started again after the brake operation signal has been released, i.e., after about 250 ms from stopping of the DC motor. Thus, the restart of the DC motor is delayed for some time after the ON operation of the operation switch.

Therefore, there is a need in the art for a power tool, in which a DC motor can be started immediately after turning on an operation switch.

### SUMMARY OF THE INVENTION

One aspect according to the present invention includes a power tool including a control device that can output a brake operation signal to a DC motor to apply a short-circuit brake thereto in response to the operation of an operation switch to an off position. The brake operation signal is stopped depending on the rotational speed of the motor when the operation switch is operated to the off position during the rotation of the DC motor.

### BRIEF DESCRIPTION OF THE DRAWINGS

FIG. 1 is a circuit configuration of a motor drive circuit of a screw tightening tool according to an embodiment of the present invention;

FIG. 2 is a schematic side view of the screw tightening tool;

FIG. 3 is a graph showing changes with time of a brake operating signal, a trigger signal and a rotational speed of a brush-less DC motor of the screw tightening tool; and

FIG. 4 is a flowchart showing a control process of the DC motor.

### DETAILED DESCRIPTION OF THE INVENTION

Each of the additional features and teachings disclosed above and below may be utilized separately or in conjunction with other features and teachings to provide improved power tools. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

In one embodiment, a screw tightening tool includes an operation switch, a brush-less DC motor and a control circuit. The brush-less DC motor is coupled to the operation switch. An electric power is supplied to the DC motor for rotating the DC motor when the operation switch is turned on and no electric power is supplied to the DC motor for rotating the DC motor when the operation switch is turned off. The control circuit is coupled to the DC motor and capable of outputting a brake operation signal to the DC motor for decreasing the rotational speed of the DC motor. When the operation switch is turned on immediately after being turned off during the rotation of the DC motor, the control circuit releases the brake operation signal immediately after the DC motor has stopped or before the DC motor is stopped. The time after the operation switch has been turned on until the rotational speed of the DC motor reaches to 60% of a normal rotational speed of the DC motor is set to be between 20 ms and 130 ms.

With this arrangement, it is possible to quickly restart the DC motor in comparison with an arrangement in which the brake operation signal is released after a predetermined time from stopping the DC motor. In addition, the rotational speed of the DC motor reaches to 60% of a normal rotational speed of the DC motor after between 20 ms and 130 ms from turning on the operation switch. Therefore, the responsiveness of the motor speed control can be improved. Here, the term “normal rotational speed” is used to mean the rotational speed of the DC motor achieved when the rotation of the DC motor has become in stable. In the case of a screw tightening tool having a trigger-type operation switch and having a plurality of speed modes that can be electrically changed, the normal rotational speed may mean the rotational speed of the DC motor achieved when the rotation of the DC motor has become in stable in the selected speed mode while the operation switch being held to be fully pulled.

The screw tightening tool may further include a detection device capable of detecting the rotational speed of the DC motor, so that the brake operation signal can be released at a suitable timing based on the rotational speed of the DC motor.

The control circuit may be configured to be able to release the brake operation signal on the condition that the rotational speed of the DC motor has been lowered to be equal to or less than 60% of the normal rotational speed. With this arrangement, it is possible to improve the responsiveness of the DC motor to the operation for turning on the operation switch.

In another embodiment, when the operation switch is turned on immediately after being turned off during the rotation of the DC motor, the control circuit releases the brake operation signal after between 20 ms and 80 ms from starting to output the brake operation signal. In addition, the time after the operation switch has been turned on until the rotational speed of the DC motor reaches to 60% of a normal rotational speed of the DC motor is set to be between 20 ms and 130 ms. With this arrangement, it is possible to improve the responsiveness of the DC motor when the operation switch is turned on to restart the DC motor immediately after turning off the operation switch.

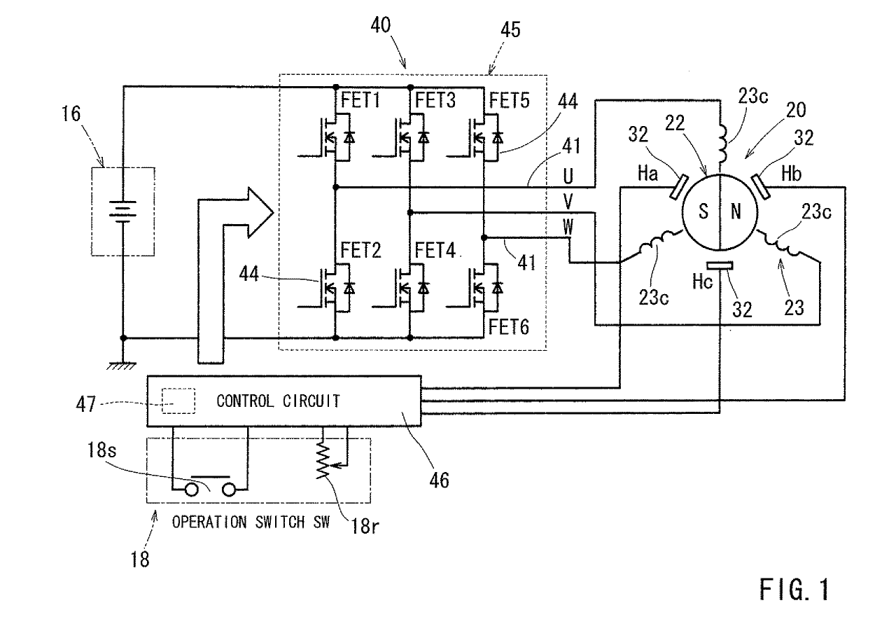

An embodiment of the present invention will now be described with reference to FIGS. 1 to 4.

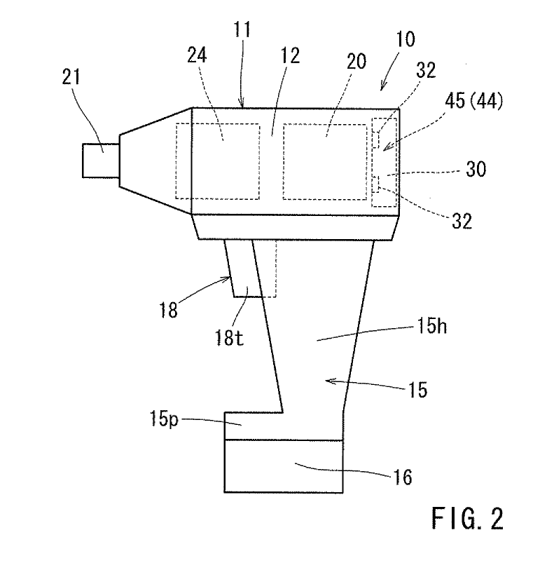

A screw tightening tool 10 of this embodiment is configured as an impact screwdriver having a brush-less DC motor 20 as a drive source. As shown in FIG. 2, the screw tightening tool 10 includes a housing 11 constituted by a tubular housing body 12 and a grip 15 protruding laterally (downwardly in FIG. 2) form the housing body 12. The grip 15 has a grip body 15h and a lower end part 15p positioned downward (leading end side) of the grip body 15h. An operator can grasp the grip body 15h with his or her hand during a tightening operation. A trigger-type operation switch 18 is provided at a base end of the grip body 15h and includes a trigger 18t that can be pulled (turned on) by a fingertip of the operator. As shown in FIG. 1, the operation switch 18 further includes a switch body 18s and a sliding resistor 18r. When the trigger 18t is operated to an on position, the switch body 18s is turned on, and an electric resistance at the sliding resistor 18r varies according to the pulling amount of the trigger 18t. When the operator releases his or her fingertip from the trigger 18r, the trigger 18r moves to an off position, and the switch body 18s is turned off.

The lower end part 15p of the grip 15 includes a coupling mechanism (not shown) for coupling to a battery pack 16 as shown in FIG. 2.

The DC motor 20 is disposed within the housing body 12. An impact drive mechanism 24 is disposed within the housing body 12 on the front side of the DC motor 20. The impact drive mechanism 24 can increase the rotational torque of the DC motor 20 and can produce an impact force applied to a tool bit 12.

As shown in FIG. 1, the DC motor 20 includes a rotor 22, a stator 23 and three magnetic sensors 32 (Ha, Hb, Hc). The rotor 22 has permanent magnets. The stator 23 has three drive coils 23c. The magnetic sensors 32 can detect the position of the magnetic poles of the rotor 22. As shown in FIG. 2, the magnetic sensors 32 are mounted to an electric circuit board 30 disposed at the rear end portion of the stator 23 and are spaced from each other by an angle of 120° about the rotor 32. A three-phase bridge circuit 45 of a motor drive circuit 40 that will be explained later is also mounted to the electric circuit board 30.

The motor drive circuit 40 is an electric circuit for driving the DC motor 20. As shown in FIG. 1, the motor drive circuit 40 includes the three-phase bridge circuit 45 and a control circuit 46. The three-phase bridge circuit 45 is constituted by six switching elements 44 (FET1-FET6). The control circuit 46 controls the switching elements 44 of the three-phase bridge circuit 45 based on an output signal from the operation switch 18.

The three-phase bridge circuit 45 includes three output lines 41 for a U-phase, a V-phase and a W-phase, which are electrically connected to the corresponding drive coils 23c (for the U-phase, the V-phase and the W-phase).

When the trigger 18t of the operation switch 18 is turned on, the control circuit 46 operates the switching elements 44 (FET1-FET6) based on the output signals from the magnetic sensors 32, so that current flows through the drive coils 23c in order, causing rotation of the rotor 22.

The control circuit 46 has a microcomputer 47 that can regulate an electric power supplied to each of the U-phase, the V-phase and the W-phase drive coils 23c under a PWM control based on change in resistance value of the sliding resistor 18r of the operation switch 18 or a previously determined motor starting characteristic. More specifically, the microcomputer 47 of the control circuit 46 can perform a PWM control of the electric power supplied to each of the drive coils 23c by a duty cycle regulation with a predetermined carrier frequency of the operations of FET2, FET4 and FET6 of the three-phase bridge circuit 45. The microcomputer 47 of the control circuit 46 also can output a brake operation signal to the three-phase bridge circuit 45 upon receipt of an off signal from the switch body 18s of the operation switch 18. When the three-phase bridge circuit 45 receives the brake operation signal, FET1, FET3 and PETS of the three-phase bridge circuit 45 are turned off, while FET2, FET4 and FET6 are turned on, so that the drive coils 23c are short-circuited to cause short-circuit brake of the DC motor 29.

Further, the microcomputer 47 of the control circuit 46 is constructed to be able to calculate the rotational speed of the DC motor 20 based on the time after one of the magnetic sensors 32 is turned on until the next one of the magnetic sensors 32 is turned off. In this way, the control circuit 46 and the magnetic sensors 32 constitute a rotation detecting device.

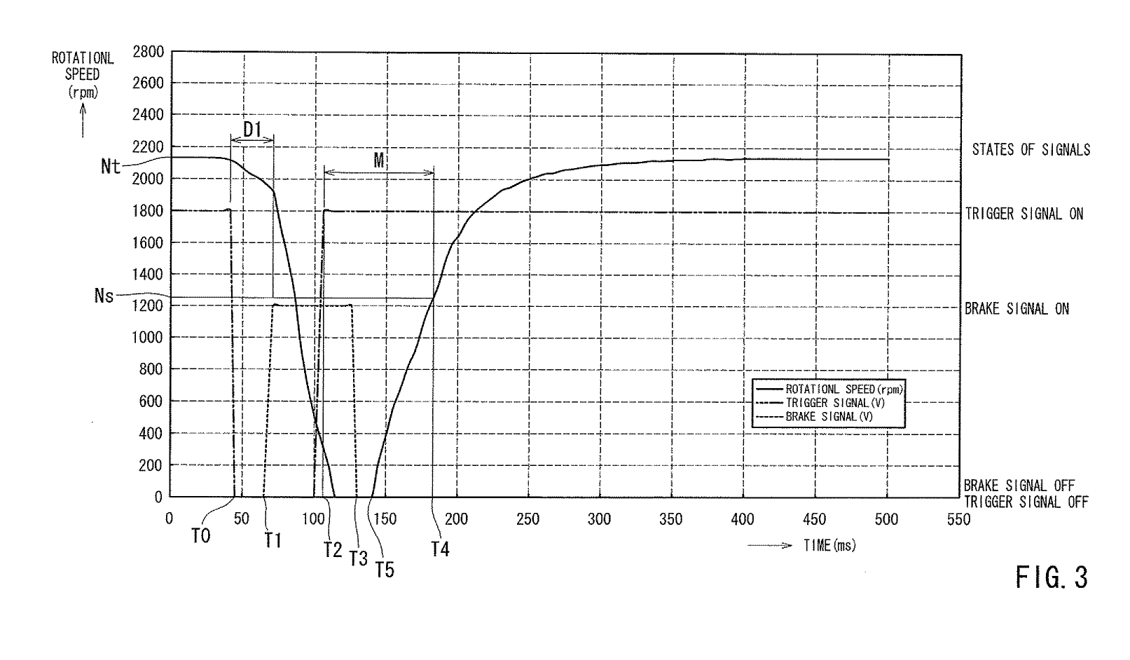

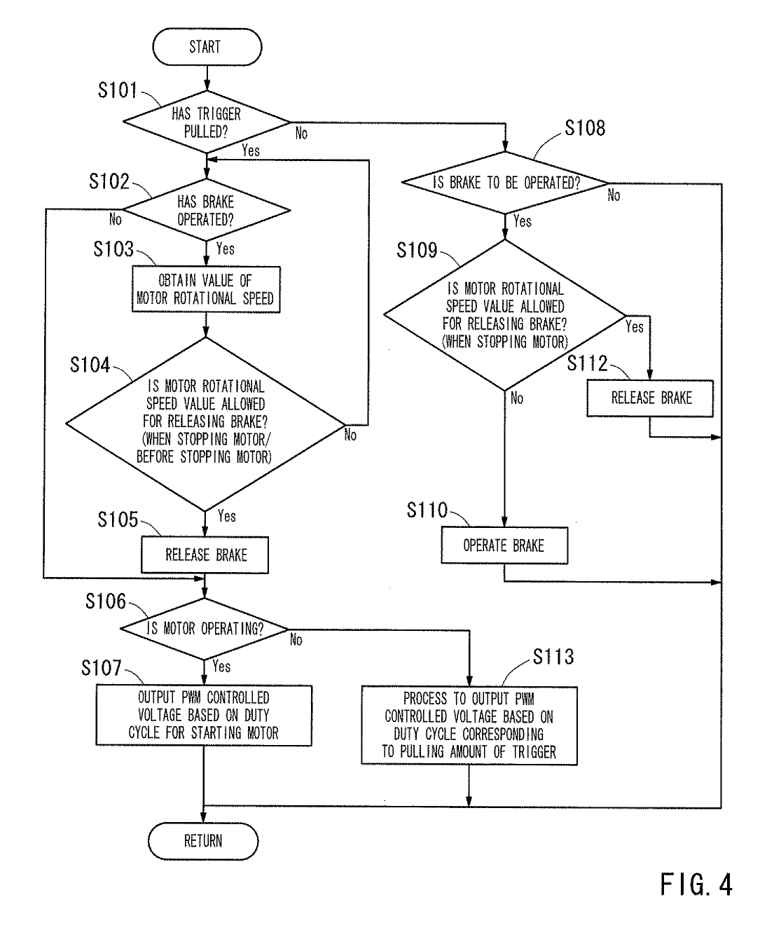

A control process performed by the microcomputer 47 of the control circuit 46 of the screw tightening tool 10 of this embodiment will now be described with reference to a graph shown in FIG. 3 and a flowchart shown in FIG. 4. In FIG. 3, an abscissa axis represents the time (ms) and an ordinate axis represents the rotational speed of the DC motor 20.

The control process will be first described in connection with the operation for starting the DC motor 20 from the state where the DC motor 20 is stopped. When the trigger 18t of the operation switch 18 is moved to the on position, the switch body 18s is turned on, so that the determination in Step S101 becomes “YES.” Then, the process proceeds to Step S102, in which it is determined whether or not the brake is operating. In the case that the DC motor 20 is started from the state where the DC motor is stopped, the determination in Step S102 becomes “NO” because no brake operating signal is outputted from the control circuit 46. The process then proceeds to Step S106, in which it is determined whether or not the DC motor 20 is operating. Because the DC motor 20 is operating in this stage, the determination in Step S106 becomes “YES” and the process proceeds to Step 107, in which the PWM control is performed for the electric power supplied to each of the U-phase, V-phase and W-phase drive coils 23c based on the predetermined motor starting characteristic.

As shown in FIG. 3, according to the predetermined motor starting characteristic, a time interval M is set to be about 75 ms. Here, the time interval M is the time after time T2 of turning on the trigger 18t of the operation switch 18 until time T4 when the rotational speed of the DC motor 20 reaches a rotational speed Ns that is 60% of a normal rotational speed Nt achieved under a normal condition, and thus, the time interval M is calculated by the expression “M=T4−T2.” Here, the normal rotational speed Nt means the rotational speed achieved when the rotation of the DC motor 20 has become in stable while the trigger 18t of the operation switch 18 being held to be fully pulled. The time interval between time T2 and time T5 is a time lag after turning on the trigger 18t until the DC motor 20 is started.

The process in Steps S101, S102, S106 and S107 is repeatedly performed until the determination in Step S106 becomes “NO” by the stop of the DC motor 20. When the determination in Step S106 becomes “NO”, the process proceeds to Step S113 where the electric power supplied to each of the U-phase, V-phase and W-phase drive coils 23c is regulated by a PWM control according to change in the resistance value at the sliding resistor 18r of the operation switch 18.

Next, the control process will be described in connection with the operation for moving the trigger 18t to the off position in the state where the DC motor 20 is operated. When the trigger 18t of the operation switch 18 is moved to the off position, the determination in Step S101 becomes “NO.” Then, the process proceeds to Step S108, in which it is determined whether or not the brake is to be operated. In this embodiment, the brake operating signal is released when the rotational speed of the DC motor 20 has become zero. Therefore, the determination in Step S108 becomes “YES” as long as the DC motor 20 is rotating. The process then proceeds to Step S109 and the determination in Step S109 becomes “NO.” The process further proceeds to Step S110 where the brake is operated. In other words, the brake operating signal is outputted from the control circuit to cause short-circuit brake of the DC motor 20.

The process in Steps S101 and S108 to S110 is repeated until the DC motor 20 is stopped (i.e., the determination in Step S109 becomes “YES”). The process then proceeds to Step S112, in which the brake operating signal is released.

Next, the control process will be described in connection with the operation of moving the trigger 18t to the off position during the operation of the DC motor 20 and moving the trigger 18t to the on position immediately after that.

As shown in FIG. 3, when the trigger 18t is moved to the off position (at time T0), the control circuit 46 outputs the brake operating signal for braking the DC motor 20 as described previously. In FIG. 3, time D1 is required for the microcomputer 47 of the control circuit 46 for recognizing the off operation of the trigger 18t and for starting the braking operation after stopping the PWM control. Thus, the output of the brake operating signal is started at time T1.

Therefore, if the trigger 18t is moved to the on position (at time T2) immediately after it has been moved to the off position, the determination in Step S102 in FIG. 4 becomes “YES” because the brake operating signal is being outputted. Then, the process proceeds to Step S103, in which the rotational speed of the DC motor 20 is detected and stored. The process further proceeds to Step S104, in which the determination is made as to whether or not the detected rotational speed is that allowed for releasing the brake. As described previously, in this embodiment, the brake operating signal is released when the rotational speed of the DC motor 20 becomes zero. Therefore, the determination in Step S104 becomes “NO.” The process in Steps S102 to S104 is repeatedly performed to output the brake operating signal until the DC motor 20 is stopped, i.e., until the determination in Step S104 becomes “YES.” The process then proceeds to Step S105, in which the brake is released (at time T3 in FIG. 3).

After Step S105, the process proceeds to Step S106 and subsequently proceeds to Step S107, in which the PWM control is performed for the electric power supplied to each of the U-phase, V-phase and W-phase drive coils 23c based on the predetermined motor starting characteristic as described previously.

With the screw tightening tool 10 of this embodiment, the brake operating signal is released shortly after the DC motor 20 has stopped. Therefore, the DC motor 20 can be restarted at an earlier time than in the known art in which the brake operating signal is released when a predetermined time has passed after stopping the motor. In addition, the time required for the DC motor 20 for reaching to 60% of the normal rotational speed Nt after turning on the operation switch 18 is set to be 75 ms. Therefore, the responsiveness can be improved.

Further, because the rotation detecting means (control circuit 46 and magnetic sensors 32) is provided for detecting the rotational speed of the DC motor 20, it is possible to release the brake operating signal at an appropriate timing according to the rotational speed of the DC motor 20.

The present invention may not be limited to the above embodiment but may be modified in various ways. For example, in the above embodiment, the predetermined motor starting characteristic is set such that the time interval M (expressed by “M=T4−T2”) is about 75 ms after time T2 of turning on the trigger 18t of the operation switch 18 until time T4 when the rotational speed of the DC motor 20 reaches the rotational speed Ns that is 60% of the normal rotational speed Nt. However, the time interval M may be set within a range of between 20 ms and 130 ms.

In addition, because the brake operation signal is released shortly after the DC motor 20 has stopped, it is possible to release the brake operation signal before the DC motor 20 stops. In such a case, it may be preferable that the brae operation signal is released on the condition that the rotational speed of the DC motor has become equal to or less than 60% of the normal rotational speed Nt. This may further improve the responsiveness of the motor to the ON operation of the operation switch 18 when the operation switch 18 is turned on shortly after the operation switch 18 has been turned OFF.

Further, the determination as to whether or not the brake operation is to be released is made according to the rotational speed of the DC motor 20. However, it is possible to output the brake operating signal during a predetermined time that may be between 20 ms and 80 ms.

Furthermore, although the above embodiment has been described in connection with the screw driving tool, the present invention may be applied to any other power tools having a DC motor capable of being braked by a short-circuit brake, and an operation switch for starting and stopping the DC motor.

1. A screw tightening tool comprising:
an operation switch;
a brush-less DC motor coupled to the operation switch;
wherein an electric power is supplied to the DC motor for rotating the DC motor in response to turning on the operation switch and no electric power is supplied to the DC motor for rotating the DC motor in response to turning off the operation switch; and
a control circuit coupled to the DC motor and capable of outputting a brake operation signal to the DC motor for decreasing the rotational speed of the DC motor;
wherein when the operation switch is turned on immediately after being turned off during the rotation of the DC motor, the control circuit releases the brake operation signal immediately after the DC motor has stopped or before the DC motor is stopped; and
wherein a time after turning on the operation switch until the rotational speed of the DC motor reaches to 60% of a normal rotational speed of the DC motor is set to be between 20 ms and 130 ms.

2. The screw tightening tool as in claim 1, further comprising a detection device capable of detecting the rotational speed of the DC motor.

3. The screw tightening tool as in claim 1, wherein control circuit is configured to be able to release the brake operation signal on the condition that the rotational speed of the DC motor has been lowered to be equal to or less than 60% of the normal rotational speed.

4. The screw tightening tool as in claim 2, wherein control circuit is configured to be able to release the brake operation signal on the condition that the rotational speed of the DC motor has been lowered to be equal to or less than 60% of the normal rotational speed.

5. A screw tightening tool comprising:
an operation switch;
a brush-less DC motor coupled to the operation switch;
wherein an electric power is supplied to the DC motor in response to turning on the operation switch and no electric power is supplied to the DC motor in response to turning off the operation switch; and
a control circuit coupled to the DC motor and capable of outputting a brake operation signal to the DC motor for decreasing the rotational speed of the DC motor;
wherein when the operation switch is turned on immediately after being turned off during the rotation of the DC motor, the control circuit releases the brake operation signal after between 20 ms and 80 ms from starting to output the brake operation signal; and
wherein a time after turning on the operation switch until the rotational speed of the DC motor reaches to 60% of a normal rotational speed of the DC motor is set to be between 20 ms and 130 ms.

6. A power tool comprising:
an operation switch operable to be turned on and off;
a DC motor; and
a control device electrically coupled between the operation switch and the DC motor;
wherein the control device can output a drive signal to the DC motor in response to turning on the operation switch;
wherein the control device can output a brake operation signal to the DC motor to apply a short-circuit brake thereto in response to turning off the operation switch,
wherein the brake operation signal is stopped depending on the rotational speed of the DC motor when the operation switch is turned off during the rotation of the DC motor.

7. The power tool as in claim 6, wherein the brake operation signal is stopped when the rotational speed of the DC motor has been lowered to a set speed.

8. The power tool as in claim 6, wherein the set speed is zero.

9. The power tool as in claim 7, wherein the set speed is 60% of a normal rotational speed of the DC motor.

10. The power tool as in claim 9, wherein a time after turning on the operation switch until the rotational speed of the DC motor reaches to the set speed is set to be between 20 ms and 130 ms.

11. The power tool as in claim 6 further comprising a rotation detection device that can detect the rotational speed of the DC motor.

12. A power tool comprising:
an operation switch capable of being turned on and off;
a DC motor; and
a control device electrically coupled between the operation switch and the DC motor;
wherein the control device can output a drive signal to the DC motor in response to turning on the operation switch;
wherein the control device can output a brake operation signal to the DC motor to apply a short-circuit brake thereto in response to turning off the operation switch; and
wherein when the operation switch is turned off during the rotation of the DC motor, the brake operation signal is stopped before the rotational speed of the DC motor is lowered to zero.

13. The power tool as in claim 12, wherein the brake operation signal is stopped when a time of between 20 ms and 80 ms has passed after turning off the operation switch during the rotation of the DC motor.

14. The power tool as in claim 13, wherein a time after turning on the operation switch until the rotational speed of the DC motor reaches to 60% of a normal rotational speed of the DC motor is set to be between 20 ms and 130 ms.
